(19) United States
(12) Patent Application Publication
(10) Pub. No.: US 2011/0268285 A1
(43) Pub. Date: Nov. 3, 2011

(54) SOUND IMAGE LOCALIZATION ESTIMATING DEVICE, SOUND IMAGE LOCALIZATION CONTROL SYSTEM, SOUND IMAGE LOCALIZATION ESTIMATION METHOD, AND SOUND IMAGE LOCALIZATION CONTROL METHOD

(75) Inventors: Yoshiki Ohta, Sakado (JP); Kensaku Obata, Saitama (JP)

(73) Assignee: PIONEER CORPORATION, Tokyo (JP)

(21) Appl. No.: 12/674,361

(22) PCT Filed: Aug. 20, 2007
(86) PCT No.: PCT/JP2007/066112

§ 371 Date: Feb. 19, 2010

(51) Int. Cl. H04R 29/00

(52) U.S. Cl. 381/58

(57) ABSTRACT

Sound pressure acquisition element integrate by time and convert into logarithms a plurality of inputted sound signals to acquire each sound pressure corresponding to the plurality of sound signals. Normalizing element normalizes each sound pressure acquired by the sound pressure acquisition element. Linear sum calculating element calculates a linear sum of each sound pressure normalized by the normalizing element using a plurality of parameters which differ for each frequency range of the sound signals.

### CROSS-REFERENCE TO RELATED APPLICATION

This is an application PCT/JP2007/66112, filed Aug. 20, 2007, which was not published under PCT article 21(2) in English.

### BACKGROUND OF THE INVENTION

1. Field of the Invention

The present invention relates to a sound image localization estimating device, sound image localization control system, sound image localization estimation method, and sound image localization control method.

2. Description of the Related Art

Recent years has witnessed the increasing widespread use of DVDs (Digital Versatile Disks), the start of terrestrial digital broadcasting, and an upsurge in the popularity of multi-channel surround sound systems, represented by the 5.1 channel surround system.

Presently, there are growing needs for technologies such as “front surround sound” that do not require the placement of speakers behind the listener. Among such needs, there is an increasing demand for technologies that assess the position of sound image localization to be generated by a plurality of speakers. From prior art, it is known that the direction of localization of the sound image perceived by the listener changes. This has resulted in the proposal of various methods for estimating the direction of localization of the sound image (“Comparison of Various Equations for Modeling Sound Image Direction in Two Channel Stereo System” [Transactions of the Institute of Electronics, Information, and Communication Engineers, Vol. J87-A, No. 12 (20041202), pp. 1549-1554]).

According to such known prior art, the following problems exist. First, even when such equations for modeling are used, the direction of localization of the sound image cannot necessarily be estimated since the sound image is made of various frequency components. Second, since the direction of localization of the sound image cannot necessarily be determined by the phase difference between channels of a two channel stereo system alone, application of such known prior art to the control of the localization direction of a sound image is difficult. Third, when an attempt is made to use such known prior art, the signal level from each speaker to both ears of the listener needs to be independently identified. Fourth, when such known prior art is used, measurement using a dummy head comprising an integrated microphone is required in the control of the direction of localization of the sound image, making such prior art not geared toward application to consumer products.

The above-described problems are given as examples of the problems that are to be solved by the present invention.

### SUMMARY OF THE INVENTION

In order to achieve the above-mentioned object, according to the first invention, there is provided a sound image localization estimating device comprising: a sound pressure acquisition unit that integrates each of a plurality of sound signals inputted by time and converts the sound signal into logarithms to acquire sound pressure corresponding to each of the plurality of sound signals; a normalizing unit that normalizes the sound pressure acquired by the sound pressure acquisition unit; and a linear sum calculating unit that calculates a linear sum of the sound pressure by means of using a plurality of estimation coefficients predetermined so that the estimation coefficients differ for each frequency range of the sound signals and calculates a localization azimuth of a sound image by means of the linear sum, the sound pressure being normalized by the normalizing unit.

In order to achieve the above-mentioned object, according to the third invention, there is provided a sound image localization control system, comprising: a test signal generating unit that generates a test signal; a sound image localization control unit that shifts per frequency range a relative phase difference of a plurality of test sounds to be outputted based on the test signal, and controls to output the plurality of test sounds; a sound image localization estimating unit that estimates per frequency range a direction of localization of a sound image formed in accordance with a relative phase difference of the plurality of test sounds, on the basis of a plurality of sound signals respectively inputted based on the plurality of test sounds; and a control unit that controls the sound image localization control unit in accordance with the localization direction of the sound image estimated per frequency range by the sound image localization estimating unit, and adjusts per the frequency range the relative phase difference of the plurality of test sounds.

In order to achieve the above-mentioned object, according to the eighth invention, there is provided a sound image localization estimating method comprising the steps of: a sound pressure acquiring step for integrating each of a plurality of sound signals inputted by time and converting the sound signal into logarithms to acquire sound pressure corresponding to each of the plurality of sound signals; a normalizing step for normalizing the sound pressure acquired by the sound pressure acquiring step; and a linear sum calculating step for calculating a linear sum of the sound pressure by means of using a plurality of estimation coefficients predetermined so that the estimation coefficients differ for each frequency range of the sound signals and calculating a localization azimuth of a sound image by means of the linear sum, the sound pressure being normalized at the normalizing step.

In order to achieve the above-mentioned object, according to the ninth invention, there is provided a sound image localization control method comprising the steps of: a test signal generating step for generating a test signal; a sound image localization control step for shifting per frequency range a relative phase difference of a plurality of test sounds to be outputted based on the test signal, and controlling to output the plurality of test sounds; a sound image localization estimating step for estimating per frequency range a direction of localization of a sound image formed in accordance with a relative phase difference of the plurality of test sounds, on the basis of a plurality of sound signals respectively inputted based on the plurality of test sounds; and a control step for adjusting per the frequency range the relative phase difference of the plurality of test sounds at the sound image localization control step in accordance with the localization direction of the sound image estimated per frequency range by the sound image localization estimating step.

### BRIEF DESCRIPTION OF THE DRAWINGS

FIG. 1 is a block diagram illustrating a hardware configuration example of a sound image localization adjusting device comprising a built-in sound image localizing unit of the present embodiment.

FIG. 2 is a block view illustrating an electrical configuration example of the sound image localization control unit shown in FIG. 1.

FIG. 3 is a block view illustrating a specific configuration example of the localization estimating unit shown in FIG. 1.

FIG. 4 illustrates a layout example of the speakers of localization control of the sound image used in an experiment of embodiment 1.

FIG. 5 is a diagram illustrating an arrangement example of each microphone of the layout example of FIG. 4.

FIG. 6 is a diagram illustrating an example of calculating the estimation coefficients used for the linear sum calculation by the localization estimating unit.

FIG. 7 is a diagram illustrating an example of the estimation results of the localization estimating unit using the estimation coefficients of FIG. 6.

FIG. 8 is a flowchart illustrating an example of the procedure for adjusting the localization azimuth of the sound image to be estimated by the localization estimating unit.

FIG. 9 is a block diagram illustrating an electrical configuration example of the sound image localization control unit of the sound image localization control system of embodiment 2.

FIG. 10 illustrates a layout example of the speakers of localization control of the sound image used in an experiment of embodiment 2.

### DETAILED DESCRIPTION OF THE PREFERRED EMBODIMENTS

The following describes embodiments of the present invention with reference to accompanying drawings.

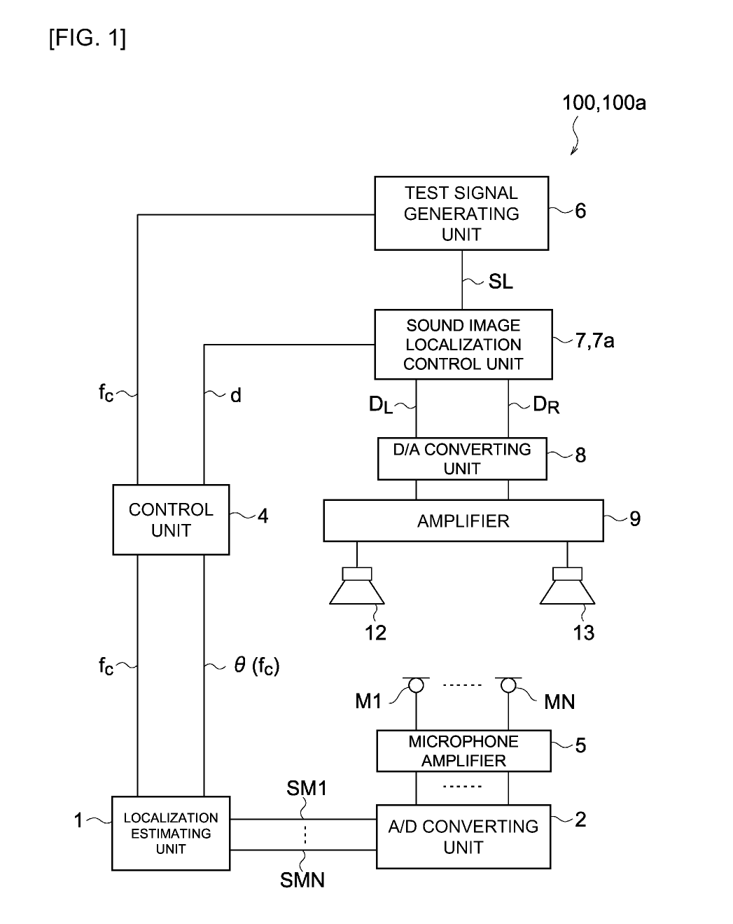

FIG. 1 is a block diagram illustrating a hardware configuration example of a sound image localization adjusting device 100 comprising a built-in localization estimating unit 1 of the present embodiment.

The sound image localization adjusting device 100 is equivalent to a sound image localization control system, and has a function of respectively outputting a. plurality of test sounds from a plurality of speakers 12 and 13, estimating the direction of localization of a sound image based on a plurality of sounds signals respectively inputted in accordance with the plurality of test sounds, and adjusting the direction of localization accordingly.

The sound image localization adjusting device 100 comprises a microphone amplifier 5, an A/D converting unit 2, the localization estimating unit 1, a control unit 4, a test signal generating unit 6, a sound image localization control unit 7, a D/A converting unit 8, and an amplifier 9. Microphones M1 to MN are detachably connected to the microphone amplifier 5 and the speakers 12 and 13 are detachably connected to the amplifier 9. Note that the sound image localization adjusting device 100 may also be designed to comprise the speakers 12 and 13 and the microphones M1 to MN.

The control unit 4 is connected to the test signal generating unit 6, the sound image localization control unit 7, and the localization estimating unit 1, and controls the sound image localization adjusting device 100 in general by controlling the test signal generating unit 6 and other units. The control unit 4 provides a predetermined center frequency fc to the test signal generating unit 6, and a predetermined parameter d to the sound image localization control unit 7. Further, the control unit 7 provides the center frequency fc to the localization estimating unit 1.

The test signal generating unit 6 generates a test signal SL for outputting a test sound of a frequency range of the center frequency fc based on the center frequency fc received from the control unit 4, and outputs the generated test signal SL to the sound image localization control unit 7.

The sound image localization control unit 7 has a function of shifting per frequency range a relative phase difference of the plurality of test sounds to be outputted based on this test signal SL, and outputting the plurality of test sounds. The sound image localization control unit 7 outputs test signals DL and DR thus shifted to the D/A converting unit 8. The shifted test signals DL and DR are signals for outputting test sounds from the left side and right side, respectively.

The D/A converting unit 8 is connected to the sound image localization control unit 7 and the amplifier 9. The D/A converting unit 8 converts each of the shifted test signals DL and DR from digital to analog, and outputs the converted signals to the amplifier 9. The amplifier 9 amplifies the shifted test signals DL and DR, outputs a test sound from the speaker 12 (equivalent to sound output unit) based on the shifted test signal DL, and outputs a test sound from the speaker 13 (equivalent to a sound output unit) based on the shifted test signal DR.

On the other hand, the microphones M1 to MN are equivalent to a sound input unit, and pick up the test sound thus outputted from the speaker 12 and output an input signal based on that test sound to the microphone amplifier 5.

The microphone amplifier 5 amplifies each input signal from the microphones M1 to MN, and outputs the amplified signals SM1 to SMN to the A/D converting unit 2. The A/D converting unit 2 converts the amplified signals SM1 to SMN from analog signals to digital signals by sampling the signals using a predetermined sampling frequency, and outputs the converted signals to the localization estimating unit 1.

The localization estimating unit 1 is equivalent to a sound image localization estimating unit or a sound image localization estimating device. The localization estimating unit 1 estimates per frequency range the direction of localization of the sound image formed in accordance with the relative phase difference of the plurality of test sounds, from the plurality of sound signals respectively inputted based on the plurality of test sounds.

The localization estimating unit 1 has a function of estimating the direction of localization of the sound image as described later, based on the amplified signals SM1 to SMN, for each center frequency fc received from the control unit 4. Then, the localization estimating unit 1 outputs to the control unit 4 the localization direction (localization azimuth) θ of the sound image of the estimation result in association with the center frequency fc. A more detailed description of the configuration and functions related to the localization estimating unit 1 will be provided later.

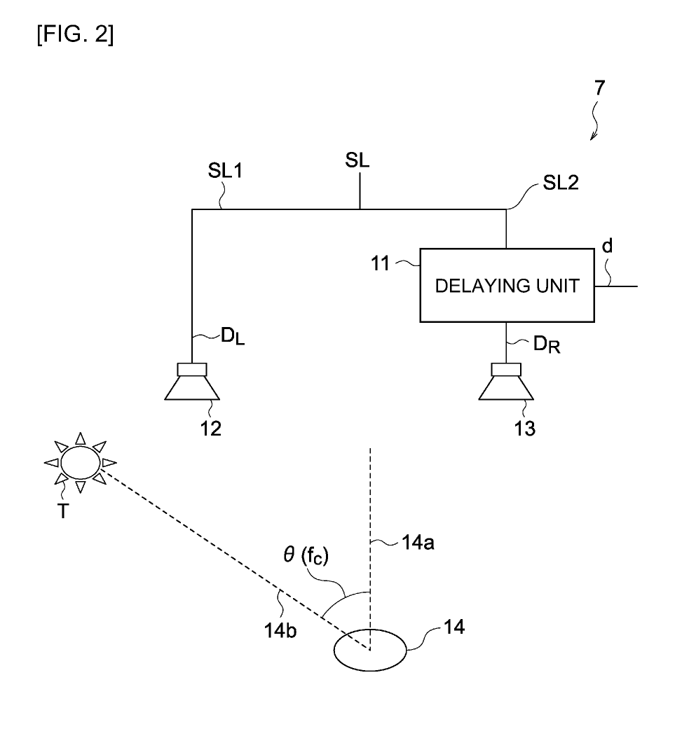

FIG. 2 is a block view illustrating an electrical configuration example of the sound image localization control unit 7 shown in FIG. 1. Note that, for clarity purposes, FIG. 2 shows the speakers 12 and 13 that are not included in the sound image localization control unit 7. Additionally, FIG. 2 shows a person 14 to target in place of the above-described microphones M1 to MN to describe a localization azimuth θ of the sound image.

First, the localization azimuth θ of the sound image of the embodiment will be described. According to the embodiment, given a frontal direction 14a of the person 14 as the center, when a localization direction 14b of a sound image T is inclined to the left (to the microphone 12), the localization azimuth θ of the sound image is a positive value. On the other hand, when the localization direction 14b of the sound image T is inclined to the right (to the microphone 13), the localization azimuth θ of the sound image is a negative value.

Next, a configuration example of the sound image localization control unit 7 will be described. The sound image localization control unit 7 comprises a delaying unit 11. This delaying unit 11 has a function of multiplying one test signal SL1 branched from the inputted test signal SL by a coefficient (hereinafter referred to as a delay value DLY) given as one parameter example to produce a relative phase difference between the test signal SL1 and the other test signal SL2. According to this embodiment, the sound image localization control unit 7 outputs the one test signal SL1 as the test signal DL, and the other test signal SL2 as the test signal DR.

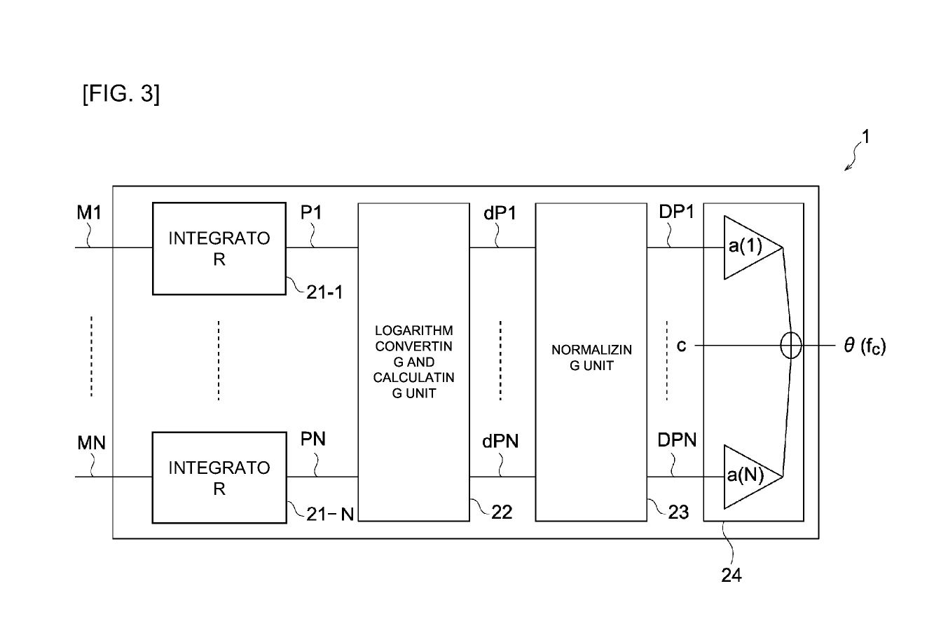

FIG. 3 is a block view illustrating a specific configuration example of the localization estimating unit 1 shown in FIG. 1.

The localization estimating unit 1 comprises integrators 21-1 to 21-N, a logarithm converting and calculating unit 22, a normalizing unit 23, and a linear sum calculating unit 24. Note that the integrators 21-1 to 21-N are provided correspondingly to the above-described microphones M1 to MN.

The integrators 21-1 to 21-N are equivalent to a portion of sound pressure acquisition unit, and have a function of integrating by time the plurality of inputted sound signals M1 to MN, and outputting the integrated signals P1 to PN to the logarithm converting and calculating unit 22. Note that, of these integrators 21-1 to 21-N, only integrators 21-1 and integrator 21-N are illustrated, and the illustrations of the other integrators 21-2, etc., are omitted.

The logarithm converting and calculating unit 22 is equivalent to a portion of the sound pressure acquisition unit, and converts the inputted integrated signals P1 to PN to logarithms, and calculates and outputs sound pressure levels dP1 to dPN [dB] to the normalizing unit 23. This normalizing unit 23 normalizes each of the sound pressure levels dP1 to dPN calculated by the logarithm converting and calculating unit 22. Specifically, the normalizing unit 23 makes the minimum value of the sound pressure levels dP1 to dPN become 0 [dB] by normalizing the other sound pressure levels, and outputs the sound pressure levels as normalized signals DP1 to DPN to the linear sum calculating unit 24.

The linear sum calculating unit 24 calculates the linear sum of the normalized signals DP1 to DPN using estimation coefficients a(1) to a(N) and c, which differ per frequency range of the above-described sound signals.

Specifically, the linear sum calculating unit 24 multiplies each of the sound pressures DP1 to DPN normalized by the normalizing unit 33 by each of the estimation coefficients a(1) to a(N), respectively, and calculates the linear sum. Furthermore, the linear sum calculating unit 24 adds the constant c to the calculated result. That is, the linear sum calculating unit 24 calculates a(1)×DP1+a(2)×DP2+ . . . +a(N−1)×DPN−1+a(N)×DPN+c.

Thus, the sound image localization adjusting device 100 with the built-in localization estimating unit 1 has a configuration such as the configuration example described above. An operation example of the localization estimating unit 1 and the sound image localization adjusting device 100 will now be described with reference to FIG. 1 to FIG. 3. First, the layout of the speakers 12 and 13 will be described.

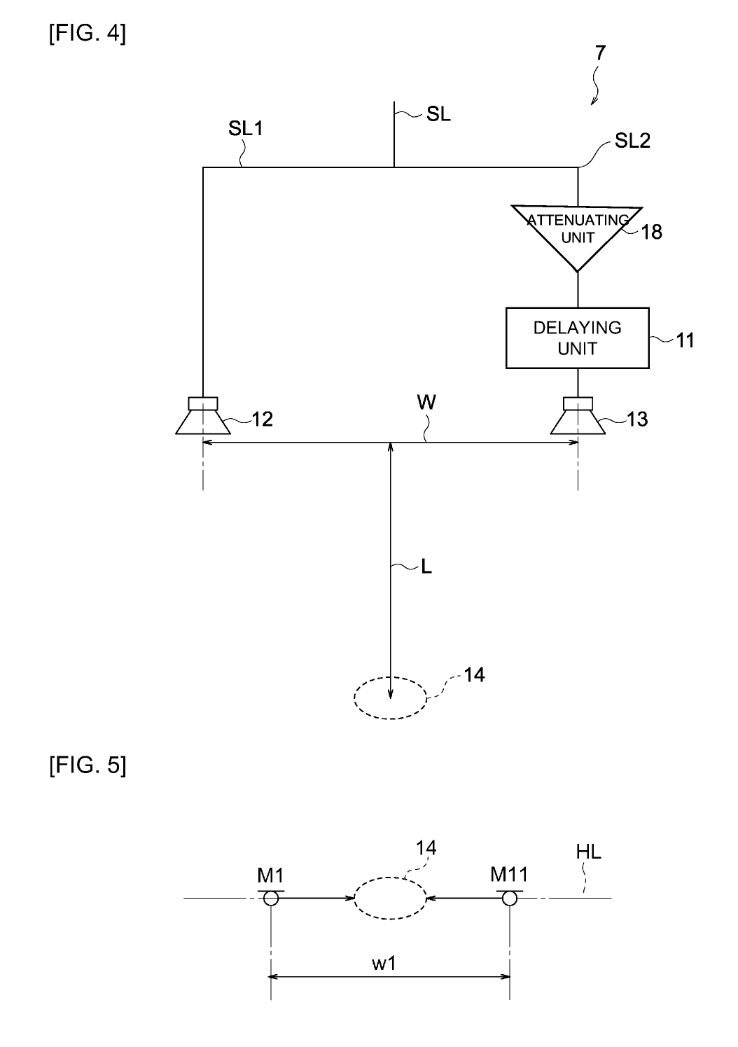

FIG. 4 illustrates a layout example of the speakers 12 and 13 used in an experiment of a localization control example of a sound image of embodiment 1.

In this experiment example, the two speakers 12 and 13 are placed in horizontally symmetrical locations at a width W [m] in place of the person 14, at a distance L [m] from the front surface of the location where the person 14 had existed. The distance L is 2 [m], for example, and the width W is 1.5 [m], for example.

A band noise (having a ⅓-octave width) of a center frequency of 1 kHz, for example, is used as the input to the sound image localization control unit 7. This sound image localization control unit 7 outputs from the right speaker 13 a signal component that is attenuated by −3 dB, for example, by an attenuating unit 18 and delayed by the delay value DLY by the delaying unit 11, and outputs from the left speaker 13 a signal component that is neither attenuated nor delayed.

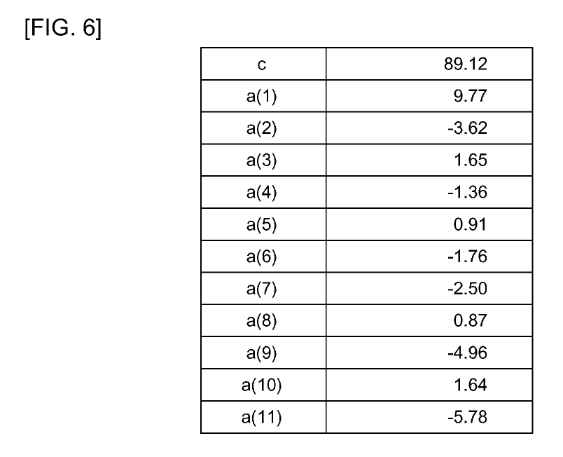

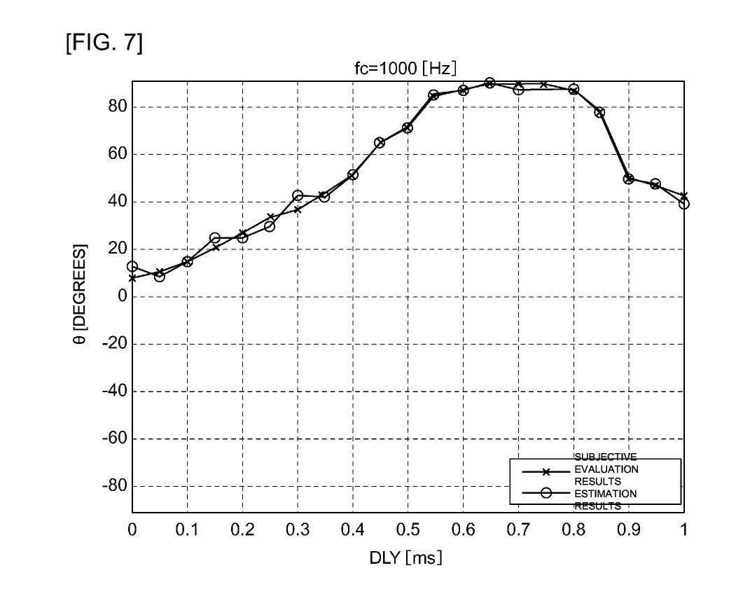

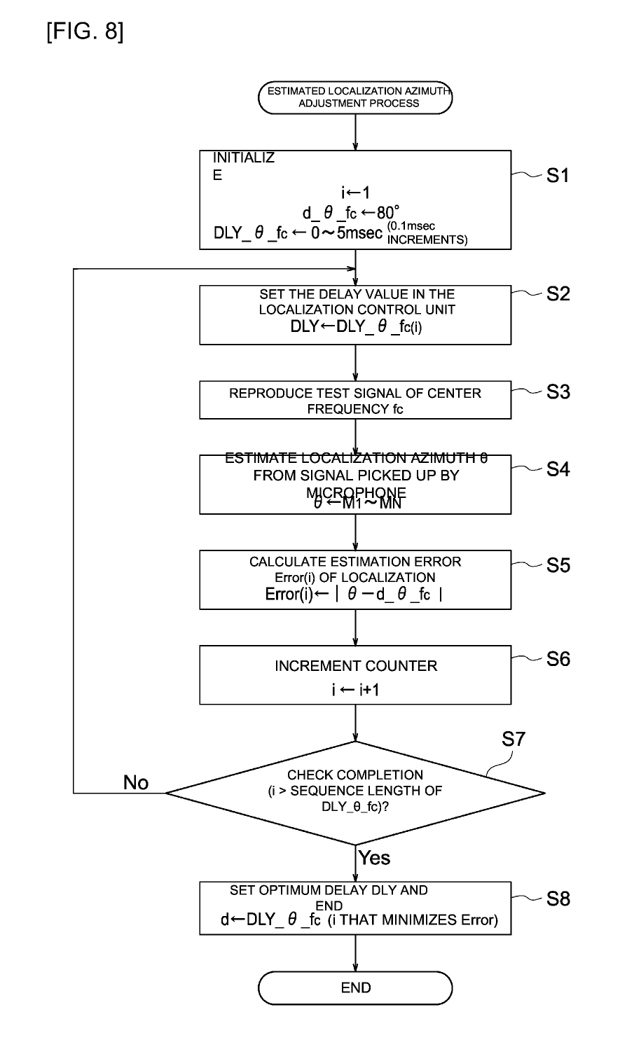

According to this experiment example, the average results of the evaluations conducted by seven test persons to target, for example, of the localization azimuth θ of the sound image based on the same concept as in FIG. 2 were plotted using “x” marks in FIG. 7, described later, in accordance with the delay value DLY. Note that, in this experiment example, the arrangement example of the microphones is as illustrated in FIG. 5 described later, and the estimation coefficients a(1) to a(N) and c used in the calculation of the linear sum by the localization estimating unit 1 are as indicated in FIG. 6 described later.

FIG. 5 is a diagram illustrating an arrangement example of each microphone of the layout example of FIG. 4. According to this example, given 11 as the number of microphones N, microphones M1 to M11 are arranged. When a distance w1 is 0.5 [m], for example, each of the microphones M1 to M11 are arranged at an interval of 5 [m], etc.

For example, the eleven microphones M1 to M11 are arranged along an alignment location HL that is substantially parallel to the aligned direction of the speakers 12 and 13. These microphones M1 to M11 are aligned along the line HL that, in the case where the person 14 existed, connects to both ears of the person 14.

These microphones M1 to M11 constitute a sound input unit for picking up the test sounds outputted from the speakers 12 and 13 by the control of the sound image localization control unit 7, and observing the characteristics of the sound field by the localization estimating unit 1 and the control unit 4 of the subsequent stage.

FIG. 6 is a diagram illustrating an example of calculating the estimation coefficients c and a(1) to a(11) used for calculating the linear sum by the localization estimating unit 1.

The estimation coefficients c and a(1) to a(11) are values found by executing multiple regression analysis from the correspondence between the signals M1 to M11 acquired by the microphones M1 to M11 and the azimuth θ at that time, and are used for the linear sum performed by the localization estimating unit 1.

FIG. 7 is a diagram illustrating an example of the estimation results achieved by the localization estimating unit 1 using the estimation coefficients c and a(1) to a(11) shown in FIG. 6. In FIG. 7, the azimuth θ of the sound image of the subjective evaluation results of the person 14 are plotted using “x” marks, and the azimuth θ of the sound image of the estimation results of the localization estimating unit 1 are plotted using “O” marks. Note that the results of FIG. 6 and FIG. 7 are values obtained in a case where the amount of attenuation by the attenuating unit 18 of FIG. 4 fixed to is −3 dB, for example.

According to the illustrated example, the azimuth θ of the sound image increases as the delay value DLY increases from 0 [ms] to 0.6 [ms], and decreases from a peak of about 0.7 [ms] to 1.0 [ms]. When the delay value DLY is 0.7 [ms], the azimuth θ of the sound image is substantially close to 90 [°], and the state is such that the sound image is directly horizontal. The subjective evaluation results were then averaged, showing a high azimuth θ estimation accuracy of an error of about two degrees.

It should be noted that, from this estimation method, only the sound pressure distribution in the area surrounding the head portion of the person 14 needs to be understood by the microphones M1 to M11. As a result, the layout of the speakers 12 and 13 is not limited to such a layout as shown in FIG. 4. Further, given a case where the center frequency is 1 [kHz] and the band width is ⅓ octave, for example, the estimation results of such an embodiment can be identified if the estimation coefficients of FIG. 6 are prepared in accordance with the center frequency and band width.

FIG. 8 is a flowchart illustrating an example of the procedure for adjusting the localization azimuth θ of the sound image to be estimated by the localization estimating unit 1. That is, this flowchart indicates an example of the procedure for approximating the localization azimuth θ of the sound image to be estimated by the localization estimating unit 1 to a desired value.

First, in step S1, the control unit 4 initializes the parameters to be delivered to the sound image localization control unit 7. Specifically, the control unit 4 sets a counter i to 1 and a target localization azimuth d_θ_fc of the target sound image to 80 degrees, for example. According to this embodiment, given the case where the person 14 existed as shown in FIG. 2, the localization azimuth θ of the direction in which the person 14 faces the center direction 14a of the speakers 12 and 13 is 0 degrees.

The sound image localization control unit 7 activates the delay value DLY of the control signal from the control unit 4, and selects an optimum value from DLY_θ_fc. According to this embodiment, the sound image localization control unit 7 activates the delay value DLY every 0.1 [msec] within a range of 0 to 5 [msec].

In the next step S2, the control unit 4 sets the delay value DLY corresponding to the above-described counter. In the next step S3, the control unit 4 performs control so that the test sound of the center frequency fc is played from the test sound generating unit 6. Note that, in this embodiment, the test sound is also referred to as “band noise.”

In the next step S4, while the test sound is playing, the localization estimating unit 1 estimates the localization azimuth θ of the sound image based on the input signals SM1 to SMN (where N=11 in this example) respectively obtained from the microphones M1 to M11 based on this test sound.

Specifically, first the integrators 21-1 to 21-N integrate by time the plurality of sound signals SM1 to SM11 respectively inputted from the microphones M1 to MN, for example, and outputs the integrated signals P1 to P11 to the logarithm converting and calculating unit 22. The logarithm converting and calculating unit 22 respectively converts the inputted integrated signals P1 to PP1 into logarithms, calculates the sound pressure levels dp1 to dP11 [dB], and outputs the levels to the normalizing unit 23.

The normalizing unit 23 normalizes each of the noise pressure levels dP1 to dP11 thus calculated by the logarithm converting and calculating unit 22. Specifically, the normalizing unit 23 makes the minimum value of the sound pressure levels dP1 to dP11 become 0 [dB] by normalizing the other sound pressure levels, and outputs the sound pressure levels as the normalized signals DP1 to DP11 to the linear sum calculating unit 24.

The linear sum calculating unit 24 calculates the linear sum of these normalized signals DP1 to DP11 using the estimation coefficients c, which differs for each frequency range of the above-described sound signals. Specifically, for each frequency range of the sound signals, the linear sum calculating unit 24 multiplies each sound pressure DP1 to DP11 thus normalized by the normalizing unit 33 by each estimation coefficients a(1) to a(11), respectively, and calculates the linear sum. Furthermore, the linear sum calculating unit 24 adds the constant c to the calculated result and calculates the localization azimuth θ of the sound image.

Next, in step S5, the control unit 4 calculates the estimation error Error (i) of the localization azimuth θ of the sound image estimated by the localization estimating unit 1, and the target localization azimuth d_θ_fc of the above-described sound image. Since the counter i in this example equals one, the control unit 4 calculates the estimation error Error (1).

Next, in step S6, the control unit 4 increments the counter i so that i=i+1. In the next step S7, the control unit 4 repeats the process of the above-describes steps S2 to S6 until all estimation errors Error (i) corresponding to the delay value DLY of the above-described 0 to 5 [msec] are found.

Next, in step S8, the control unit 4 outputs the delay value DLY having the minimum estimation error Error (i) as the parameter d corresponding to the center frequency fc. According to the embodiment, the control unit 4 is further capable of finding the optimum delay value DLY corresponding to each frequency range by executing each step of this flowchart for each frequency range.

The sound image localization estimating device 1 (equivalent to the localization estimating unit) of the above embodiment comprises sound pressure acquisition unit 21-1 to 21-N and 22 (equivalent to the integrators and logarithm converting and calculating unit) that integrate each of an plurality of sound signals inputted by time and convert the sound signal into logarithms to acquire sound pressure corresponding to each of the plurality of sound signals, a normalizing unit 23 that normalizes the sound pressure acquired by the sound pressure acquisition unit 21-1 to 21-N, and a linear sum calculating unit 24 that calculates a linear sum of the sound pressure normalized by the normalizing unit 23 using a plurality of estimation coefficients [equivalent to a(1) to a(N) and constant c] that differ for each frequency range of the sound signals.

With this arrangement, the normalizing unit 23 is capable of identifying the relative sound pressure gradient by each of the normalized sound pressures, making it possible for the linear sum calculating unit 24 to perform the following calculation independent of the inputted sound signal levels. That is, the linear sum calculating unit 24 is capable of calculating the linear sum of a plurality of sound pressures corresponding to a plurality of sound signals, and identifying the direction of localization of the sound image (equivalent to the localization azimuth θ of the sound image described above) formed by a plurality of sound signals in accordance with this relative sound pressure gradient.

Furthermore, the linear sum calculating unit 24 performs calculations using estimation coefficients that differ for each frequency range of the sound signals, making it possible to accurately identify the localization direction θ of the sound image, taking into consideration the frequency range of the sound signals. Thus, the linear sum calculating unit 24 is capable of closely estimating the localization direction θ of the sound image formed by the plurality of sound signals, taking into consideration the frequency range of the sound signals as well.

In the sound image localization estimating device 1 of the above embodiment, in addition to the above configuration, the linear sum calculating unit 24 further calculates the linear sum by multiplying each sound pressure normalized by the normalizing unit 23 by each of the estimation coefficients a(1) to a(N), for each frequency range of the sound signals. According to the above embodiment, this linear sum calculating unit 24 then adds the constant c to this calculation result.

The sound image localization control system 100 (equivalent to the sound image localization adjusting unit) of the above embodiment comprises test signal generating unit 6 that generates a test signal, a sound image localization control unit 7 and 7a that shifts per frequency range the relative phase difference of a plurality of test sounds to be outputted based on the test signal, and controls to output the plurality of test sounds, a sound image localization estimating unit 1 that estimates per frequency range a localization direction θ of the sound image formed in accordance with the relative phase difference of the plurality of test sounds, on the basis of a plurality of sound signals respectively inputted based on the plurality of test sounds, and a control unit 4 that controls the sound image localization control unit 7 and 7a in accordance with the localization direction θ of the sound image estimated per frequency range by the sound image localization estimating unit 1 and adjusts the relative phase difference of the plurality of test sounds for each of the frequency ranges.

With this arrangement, the control unit 4 shifts and adjusts the phase of certain test signals within a plurality of test signals per frequency range so that the localization direction θ of the sound image formed by the plurality of test sounds outputted by the sound image localization control unit 7 and 7a becomes a desired localization azimuth. Then, the control unit 4 controls the sound image localization control unit 7 and 7a so that the relative phase difference of the plurality of test sounds is not only simply adjusted, but accurately adjusted for each frequency range. As a result, compared to a case where adjustments are thus made by the phase difference only, the control unit 4 is capable of preventing a change in tone of a sound source formed by a plurality of test sounds after that adjustment. Further, the control unit 4 is capable of automatically making adjustments so that the localization direction θ of the sound image becomes the desired localization azimuth without relying on human hearing. Additionally, since the sound image localization direction and phase (DLY) are associated per frequency range, the design of the sound image localization control units 7 and 7a is simplified.

In the sound image localization control system 100 of the above embodiment, in addition to the above configuration, the sound image localization estimating unit 1 comprises a sound pressure acquisition unit 21-1 to 21-N and 22 (equivalent to the integrators and logarithm estimating unit) that integrate each of the plurality of sound signals inputted by time and convert into logarithms to acquire sound pressure corresponding to each of the plurality of sound signals, a normalizing unit 23 that normalizes the sound pressure acquired by the sound pressure acquisition unit 21-1 to 21-N, and a linear sum calculating unit 24 that calculates a linear sum of the sound pressure normalized by the normalizing unit 23 using a plurality of estimation coefficients [equivalent to a(1) to a(N) and c] that differ for each frequency range of the sound signals.

With this arrangement, the normalizing unit 23 is capable of identifying the relative sound pressure gradient by each of the normalized sound pressures, making it possible for the linear sum calculating unit 24 to perform the following calculation independent of the inputted sound signal levels. That is, the linear sum calculating unit 24 is capable of calculating the linear sum of a plurality of sound pressures corresponding to a plurality of sound signals, and identifying the direction of localization of the sound image (equivalent to the localization azimuth θ of the sound image described above) formed by a plurality of sound signals in accordance with this relative sound pressure gradient.

Furthermore, the linear sum calculating unit 24 performs calculations using estimation coefficients that differ for each frequency range of the sound signals, making it possible to accurately identify the localization direction θ of the sound image, taking into consideration the frequency range of the sound signals. Thus, the linear sum calculating unit 24 is capable of closely estimating the localization direction θ of the sound image formed by the plurality of sound signals, taking into consideration the frequency range of the sound signals as well.

Furthermore, the control unit 4 shifts and adjusts the phase of certain test signals within the plurality of test signals for each frequency range so that the localization direction θ of the sound image formed by the plurality of test sounds outputted by the sound image localization control unit 7 and 7a becomes a desired localization azimuth. Then, this control unit 4 controls the sound image localization control unit 7 and 7a so that the relative phase difference of the plurality of test sounds is not only simply adjusted, but adjusted in detail per frequency range. As a result, the control unit 4 makes adjustments using the phase difference only, thereby making it possible to prevent a change in tone of the sound source formed by the plurality of test sounds after that adjustment. Further, the control unit 4 is capable of automatically making adjustments so that the localization direction θ of the sound image becomes the desired localization azimuth without relying on human hearing.

In the sound image localization control system 100 of the above embodiment, in addition to the above configuration, the linear sum calculating unit 24 further calculates the linear sum by multiplying each sound pressure normalized by the normalizing unit 23 by each of the estimation coefficients a(1) to a(N), for each frequency range of the sound signals. Furthermore, according to the above embodiment, this linear sum calculating unit 24 then adds the constant c to this calculation result.

With this arrangement, the linear sum calculating unit 24 is capable of accurately calculating each sound pressure per frequency range of the sound signals, making it possible to accurately calculate the linear sum of each sound pressure multiplied by each estimation coefficient a(1) to a(N). As a result, the control unit 4 controls the sound image localization control unit 7 and 7a accurately adjusted per frequency range. This control unit 4 makes adjustments using the phase difference only, making it possible to prevent a change in tone of the sound source formed by the plurality of test sounds after that adjustment. Further, the control unit 4 is capable of more accurately making adjustments automatically so that the localization direction θ of the sound image becomes the desired localization azimuth without relying on human hearing.

In the sound image localization control system 100 of the above embodiment, the plurality of sound input unit M1 to MN (equivalent to microphones) for respectively inputting the plurality of sound signals are aligned along the aligned direction of both ears of a person to target when the person is presumed to exist.

With this arrangement, the sound pressure gradient of the line along the aligned direction of both ears of the person to target becomes the critical key to sound image localization, making it possible to minimize the number of sound input unit M1 to MN.

The sound image localization estimation method of the above embodiment comprises the steps of: a sound pressure acquiring step for integrating each of a plurality of sound signals inputted by time and converting the sound signal into logarithms to acquire sound pressure corresponding to each of the plurality of sound signals, a normalizing step for normalizing the sound pressure acquired by the sound pressure acquiring step, and a linear sum calculating step for calculating a linear sum of the sound pressure normalized by the normalizing step using a plurality of estimation coefficients [equivalent to a(1) to a(N) and c] that differ per frequency range of the sound signals.

With this arrangement, the normalizing step is capable of identifying the relative sound pressure gradient by each of the normalized sound pressures, making it possible for the following calculation to be performed in the linear sum calculating step independent of the inputted sound signal levels. That is, the linear sum calculating step is capable of calculating the linear sum of a plurality of sound pressures corresponding to a plurality of sound signals, and identifying the direction of localization of the sound image (equivalent to the localization azimuth θ of the sound image described above) formed by a plurality of sound signals in accordance with this relative sound pressure gradient.

Furthermore, the linear sum calculating step performs calculations using estimation coefficients that differ for each frequency range of the sound signals, making it possible to accurately identify the localization direction θ of the sound image, taking into consideration the frequency range of the sound signals. Thus, the linear sum calculating step is capable of closely estimating the localization direction θ of the sound image formed by the plurality of sound signals, taking into consideration the frequency range of the sound signals as well.

The sound image localization control method of the above embodiment comprises the steps of: a test signal generating step for generating a test signal, a sound image localization control step for shifting per frequency range the relative phase difference of a plurality of test sounds to be outputted based on the test signal, and controlling to output the plurality of test sounds, a sound image localization estimating step for estimating per frequency range a localization direction of the sound image formed in accordance with the relative phase difference of the plurality of test sounds, on the basis of a plurality of sound signals respectively inputted based on the plurality of test sounds, and a control step for adjusting per said frequency range the relative phase difference of said plurality of test sounds at said sound image localization control step in accordance with the localization direction of the sound image estimated per frequency range by said sound image localization estimating step.

With this arrangement, the control step shifts and adjusts the phase of certain test signals within the plurality of test signals for each frequency range so that the localization direction θ of the sound image formed by the plurality of test sounds outputted in the sound image localization control step becomes a desired localization azimuth. Then, the control step controls the sound image localization control step so that the relative phase difference of the plurality of test sounds is not only simply adjusted, but accurately adjusted per frequency range as well. As a result, the control step thus makes adjustments using the phase difference only, making it possible to prevent a change in tone of the sound source formed by the plurality of test sounds after that adjustment. Further, the control step is capable of automatically making adjustments so that the localization direction θ of the sound image becomes the desired localization azimuth without relying on human hearing.

### Embodiment 2

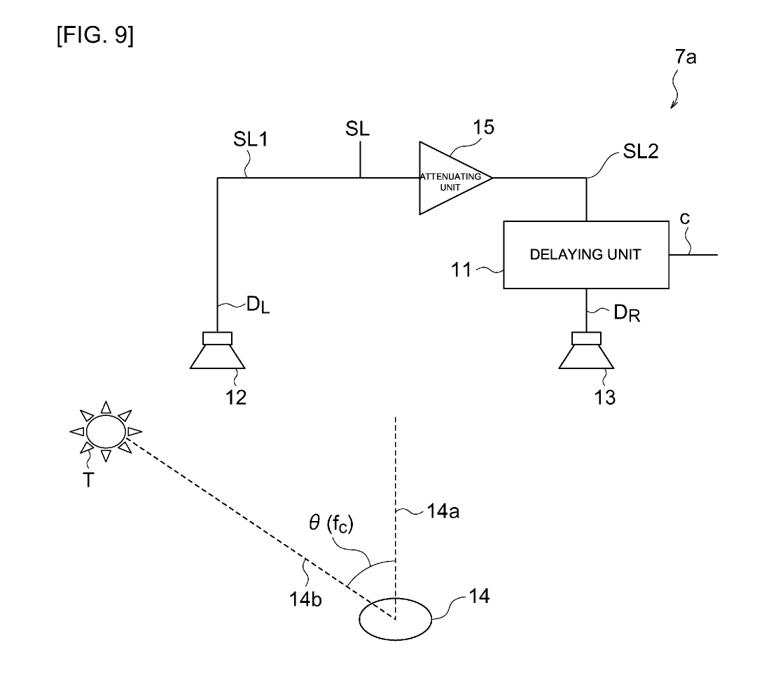

FIG. 9 is a block diagram illustrating an electrical configuration example of a sound image localization control unit 7a of the sound image localization control system 100a of embodiment 2. Note that, for clarity purposes, FIG. 2 shows the speakers 12 and 13 that are not included in the sound image localization control unit 7. Additionally, FIG. 2 shows the person 14 in place of the above-described microphones M1 to MN to describe a localization azimuth θ of the sound image.

The sound image localization control system 100a of embodiment 2 has substantially the same configuration and behaves in substantially the same manner as embodiment 1. Thus, the same reference numerals as those in FIGS. 1 to 8 of embodiment 1 denote the same components and behavior, and descriptions thereof will be omitted. The following description will focus on the differences between the embodiments.

The sound image localization control unit 7a of the sound image localization control system 100a has a different configuration than that in embodiment 1. Specifically, the sound image localization control unit 7a, in addition to the configuration of the sound image localization control unit 7 of embodiment 1, further comprises an attenuating unit 15. According to embodiment 2, this sound image localization control unit 7a generates a relative phase difference of the plurality of sound signals by the delaying unit 11 as in embodiment 1, and controls the relative attenuation difference of the plurality of sound signals by the attenuating unit 15.

The attenuating unit 15 has a function of multiplying one of the test signals SL branched from the inputted test signal SL by a certain coefficient att (attenuation) to generate a relative attenuation difference between this one test signal SL and the other test signal SL. This attenuating unit 15 outputs the one test signal SL thus attenuated to the delaying unit 11.

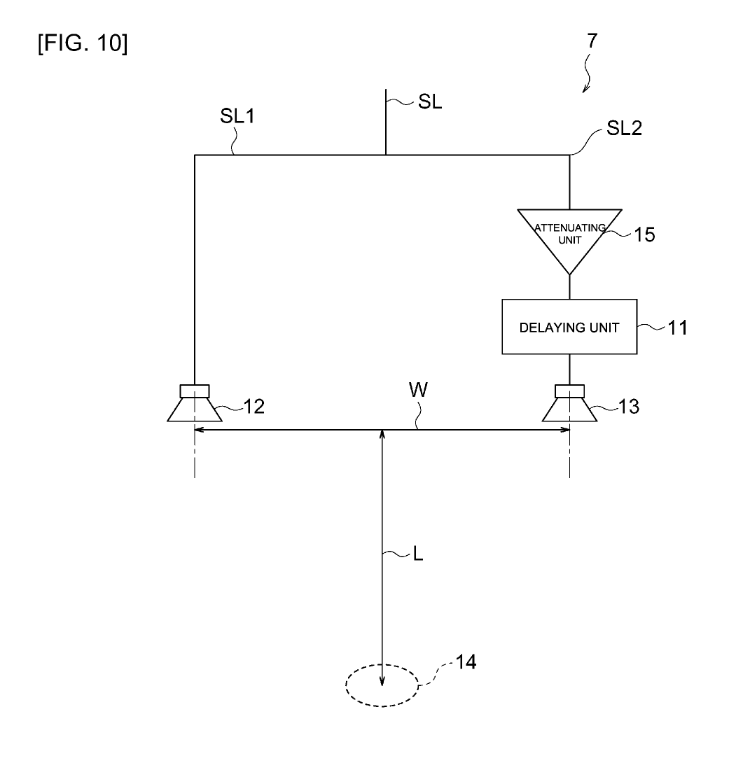

FIG. 10 illustrates a layout example of the speakers 12 and 13 used in an experiment of a localization control example of a sound image of embodiment 2. Note that, in the experiment example of FIG. 10, the experiment is conducted under substantially the same conditions as in FIG. 4.

A band noise (having a ⅓-octave width) of a center frequency of 1 kHz, for example, is used as an input to the sound image localization control unit 7a. This sound image localization control unit 7a outputs from the right speaker 13 a sound component multiplied by a delay value DLY to be multiplied by the attenuation difference att, and outputs from the left speaker 13 a signal component that is not delayed.

According to an example of results of such an experiment, the sound image localization control unit 7a is capable of performing control by phase as well as attenuation, making it possible to more accurately adjust the localization direction of the sound image.

In the sound image localization control system 100a of the above embodiment, in addition to each of the configurations of the above embodiment 1, the sound mage localization control unit 7 further comprises a attenuating unit 15 (attenuator) that produce a relative difference between attenuations (att) of the plurality of test sounds.

With this arrangement, (although the tone slightly changes,) it is possible to adjust the localization direction of the sound image with high accuracy and without waste.

Note that the embodiments of the present invention are not limited to the above, and various modifications are possible. In the following, details of such modifications will be described one by one.

The above-described localization estimating unit 1 (the sound image localization estimating device) may be applied not only to the sound image localization control systems 100 and 100a such as indicated in embodiment 1 and embodiment 1, but also to the estimation of a localization azimuth θ of a sound image produced by a voice that is to be recognized.

While, according to the above-described embodiment 2, the sound image localization control unit 7a controls the relative phase difference of the plurality of sound signals as in embodiment 1 and controls the relative attenuation of the plurality of sound signals by the attenuator 15, the sound image localization control unit 7a may instead control the relative attenuation of the plurality of sound signals by the attenuator 15 rather than control the relative phase difference of the plurality of sound signals as in embodiment 1.

1-9. (canceled)

10. A sound image localization estimating device comprising:
a sound pressure acquisition unit that integrates each of a plurality of sound signals inputted by time and converts the sound signal into logarithms to acquire sound pressure corresponding to each of said plurality of sound signals;
a normalizing unit that normalizes the sound pressure acquired by said sound pressure acquisition unit; and
a linear sum calculating unit that calculates a linear sum of the sound pressure by means of using a plurality of estimation coefficients predetermined so that the estimation coefficients differ for each frequency range of said sound signals and calculates a localization azimuth of a sound image by means of said linear sum, said sound pressure being normalized by said normalizing unit.

11. The sound image localization estimating device according to claim 10, wherein:
said estimation coefficients are calculated by executing multiple regression analysis of a correspondence between a plurality of sound signals that is inputted corresponding to sounds generated in an experiment, and a plurality of localization azimuth that is evaluated to the sounds generated subjectively by a person to target.

12. A sound image localization control system, comprising:
a test signal generating unit that generates a test signal;
a sound image localization control unit that shifts per frequency range a relative phase difference of a plurality of test sounds to be outputted based on said test signal, and controls to output said plurality of test sounds;
a sound image localization estimating unit that estimates per frequency range a direction of localization of a sound image formed in accordance with a relative phase difference of said plurality of test sounds, on the basis of a plurality of sound signals respectively inputted based on said plurality of test sounds; and
a control unit that controls said sound image localization control unit in accordance with the localization direction of the sound image estimated per frequency range by said sound image localization estimating unit, and adjusts per said frequency range the relative phase difference of said plurality of test sounds.

13. The sound image localization control system according to claim 12, wherein:
said sound image localization estimating unit comprises:
a sound pressure acquisition unit that integrates each of a plurality of sound signals inputted by time and converts the sound signal into logarithms to acquire sound pressure corresponding to each of said plurality of sound signals;
a normalizing unit that normalizes the sound pressure acquired by said sound pressure acquisition unit; and
a linear sum calculating unit that calculates a linear sum of the sound pressure by means of using a plurality of estimation coefficients predetermined so that the estimation coefficients differ for each frequency range of said sound signals and calculates a localization azimuth of the sound image by means of said linear sum, said sound pressure being normalized by said normalizing unit.

14. The sound image localization control system according to claim 13, wherein:
said estimation coefficients are calculated by executing multiple regression analysis of a correspondence between a plurality of sound signals that is inputted corresponding to sounds generated in an experiment, and a plurality of localization azimuth θ that is evaluated to the sounds generated subjectively by a person to target.

15. The sound image localization control system according to claim 12, wherein:
said sound image localization control unit comprises an attenuating unit that produces a relative difference between attenuations of said plurality of test sounds.

16. The sound image localization control system according to claim 12, further comprising
a plurality of sound input unit for respectively inputting said plurality of sound signals aligned along an aligned direction of both ears of a person to target in a case where said person is assumed to exist.

17. A sound image localization estimating method comprising the steps of:
a sound pressure acquiring step for integrating each of a plurality of sound signals inputted by time and converting the sound signal into logarithms to acquire sound pressure corresponding to each of said plurality of sound signals;
a normalizing step for normalizing the sound pressure acquired by said sound pressure acquiring step; and
a linear sum calculating step for calculating a linear sum of the sound pressure by means of using a plurality of estimation coefficients predetermined so that the estimation coefficients differ for each frequency range of said sound signals and calculating a localization azimuth of a sound image by means of said linear sum, said sound pressure being normalized at said normalizing step.

18. A sound image localization control method comprising the steps of:
a test signal generating step for generating a test signal;
a sound image localization control step for shifting per frequency range a relative phase difference of a plurality of test sounds to be outputted based on said test signal, and controlling to output said plurality of test sounds;
a sound image localization estimating step for estimating per frequency range a direction of localization of a sound image formed in accordance with a relative phase difference of said plurality of test sounds, on the basis of a plurality of sound signals respectively inputted based on said plurality of test sounds; and
a control step for adjusting per said frequency range the relative phase difference of said plurality of test sounds at said sound image localization control step in accordance with the localization direction of the sound image estimated per frequency range by said sound image localization estimating step.
